(19) United States
(12) Patent Application Publication
(10) Pub. No.: US 2026/0154461 A1
(43) Pub. Date: Jun. 4, 2026

(54) SEMICONDUCTOR DEVICE AND FAULT INJECTION DETERMINATION METHOD

(71) Applicant: Renesas Electronics Corporation, Tokyo (JP)

(72) Inventor: Takahiko SUGAHARA, Tokyo (JP)

(21) Appl. No.: 18/926,503

(22) Filed: Oct. 25, 2024

(30) Foreign Application Priority Data
Dec. 14, 2023 (JP) 2023-211045

(51) Int. Cl. G06F 21/72; H10W 42/40

(52) U.S. Cl. CPC G06F 21/72; G06F 21/00; G06F 21/60; G06F 21/602; G06F 21/64; G06F 21/70; G06F 21/71; G06F 21/78; H10W 42/405; G06F 2212/402; G06F 2213/0038

(57) ABSTRACT

To suppress false detection of fault injection, the fault injection detector detects the fault injection. The encryption module generates the first encrypted data by encrypting the plaintext data. The controller verifies the encrypted data generated by the encryption module and determines whether the encrypted data is valid if fault injection is detected in the fault injection detector.

### CROSS-REFERENCE TO RELATED APPLICATIONS

The disclosure of Japanese Patent Application No. 2023-211045 filed on Dec. 14, 2023, including the specification, drawings and abstract is incorporated herein by reference in its entirety.

### BACKGROUND

The present disclosure relates to a semiconductor device and a fault injection determination method, for example, a semiconductor device having a functional portion for performing encryption processing, and a fault injection determination method in such a semiconductor device.

Encryption techniques are used for secure communication and data secrecy. Encryption techniques are widely used in personal information devices such as IC (Integrated Circuit) cards. In recent years, the importance of encryption has also increased in ECU (Electronic Control Unit) which are mounted inside a car and electronically control each part inside vehicles.

However, even though encryption techniques are logically secure, fault attacks targeting physical vulnerabilities such as Differential Fault Analysis (DFA) have become practical threats. In DFA attacks, attackers instantaneously give power glitches and other abnormal voltages to electronic equipment equipped with encryption techniques. An attacker deliberately causes a faulty operation and retrieves ciphertexts containing the correct ciphertext and errors. The attacker analyzes the difference between the correct ciphertext and the ciphertext containing the error and estimates the secret key.

There are disclosed techniques listed below.

[Non-Patent Document 1] A. G. Yanci, S. Pickles, and T. Arslan, “Characterization of a voltage glitch attack detector for secure devices”, 2009 Symposium on Bio-inspired Learning and Intelligent Systems for Security, pages 91 {96. IEEE, 2009.

[Non-Patent Document 2] D. El-Baze, J.-B. Rigaud, and P. Maurine. “A Fully-Digital EM Pulse Detector”. Design, Automation & Test in Europe Conference & Exhibition (DATE), 2016, pages 439-444. IEEE, 2016

As a countermeasure against fault attacks, fault injection detectors are known to detect fault injection such as power glitches and electromagnetic wave irradiation. For example, Non-Patent Document 1 discloses an analog sensor used in the fault injection detector. Further, Non-Patent Document 2 discloses a digital detector used in the fault injection detector.

### SUMMARY

As a fault injection detector, the analog sensor and a digital detector is known. However, for both the analog sensor and the digital detector, it is difficult to distinguish between the voltage glitch and the electromagnetic wave irradiation and noise, sometimes erroneously detect such as a mere voltage variation and fault injection.

Other objects and novel features will become apparent from the description of this specification and the accompanying drawings.

According to one embodiment, a semiconductor device is provided. The semiconductor device includes a fault injection detector, an encryption module, and a controller. The controller verifies the encrypted data generated by the encryption module when fault injection is detected in the fault injection detector.

According to one embodiment, it is possible to suppress the erroneous detection of the fault injection.

### BRIEF DESCRIPTION OF THE DRAWINGS

FIG. 1 is a block diagram showing a configuration example of a semiconductor device according to a first embodiment.

FIG. 2 is a flowchart showing an operation procedure in the semiconductor device according to the first embodiment.

FIG. 3 is a block diagram showing a configuration example of a semiconductor device according to a second embodiment.

FIG. 4 is a flowchart showing an operation procedure in the semiconductor device according to the second embodiment.

FIG. 5 is a block diagram showing a configuration example of variations of the semiconductor device.

### DETAILED DESCRIPTION

Prior to the description of the embodiment, a description will be given of the history leading to conceiving the following embodiments. As a countermeasure against DFA attacks, it is conceivable that the generated ciphertext is verified and the ciphertext is outputted when it is confirmed that the ciphertext is valid. As a method for verifying ciphertext, a Doubling technique that performs encryption processing twice on plaintext and compares them is known. And, as a verification method of the ciphertext, verification technique which decrypts the encrypted data of the plaintext and compares the decrypted data with the original plaintext is known.

However, Doubling method requires two mounting of encryption circuit, which is problematic because the implementation cost is increased by a factor of two. In addition, Verification method requires that the decryption process be performed after the encryption is performed, which effectively reduces the computational performance of the encryption process to ½. The present inventors have conceived of the following embodiments in order to reduce at least a portion of the above.

Hereinafter, an embodiment in which means for solving the above problem is applied will be described in detail with reference to the drawings. For clarity of explanation, the following description and drawings are appropriately omitted and simplified. In the drawings, the same elements are denoted by the same reference numerals, and a repetitive description thereof is omitted as necessary.

Although the following embodiments will be described in sections or embodiments as necessary for convenience, except where specifically stated, they are not mutually exclusive, and one is related to some or all of the other modifications, application examples, descriptions, or supplementary descriptions. In the following embodiments, the number of elements, etc. (including the number of elements, numerical values, quantities, ranges, etc.) is not limited to the specific number, but may be not less than or equal to the specific number, except for cases where the number is specifically indicated and is clearly limited to the specific number in principle.

Furthermore, in the following embodiments, the constituent elements (including the operation steps and the like) are not necessarily essential except in the case where they are specifically specified and the case where they are considered to be obviously essential in principle. Similarly, in the following embodiments, when referring to the shapes, positional relationships, and the like of components and the like, it is assumed that the shapes and the like are substantially approximate to or similar to the shapes and the like, except for the case in which they are specifically specified and the case in which they are considered to be obvious in principle, and the like. This is the same for the above-mentioned numbers and the like (including the number, numerical values, quantities, and ranges).

### First Embodiment

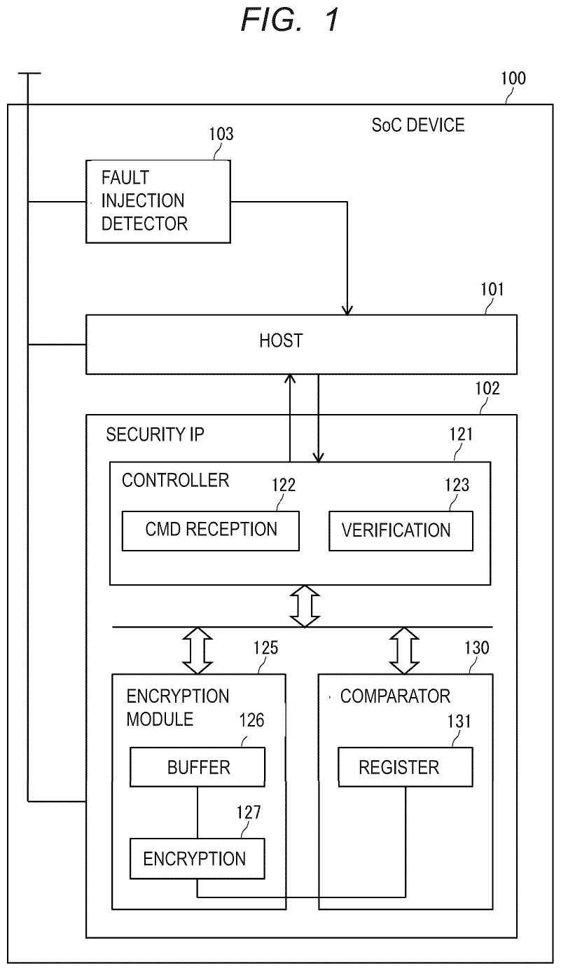

FIG. 1 shows a configuration example of a semiconductor device according to a first embodiment. The semiconductor device 100 shown in FIG. 1 includes a host 101, a security IP (Intellectual Property) 102 and a fault injection detector 103. In this embodiment, the semiconductor device 100 is configured, for example, as an SoC (System on Chip) device. The semiconductor device 100 is mounted in a vehicle, can be used in an ECU or the like for controlling the various parts of the vehicle. The semiconductor device 100, although not shown in FIG. 1 has an external interface such as a power supply terminal, and a clock terminal.

The host 101 performs various processes in the semiconductor device 100. For example, the host 101 may have one or more processors and one or more memories. At the host 101, the processor executes various processes according to a program read from the memory. The process performed by the host 101 includes the process of submitting data-encryption to the secure IP 102. When requesting data encryption from the security IP 102, the host 101 transmits the encryption instruction command and the data to be encrypted, i.e., plaintext data, to the security IP 102.

The security IP 102 is a functional unit that performs encryption processing. The security IP 102 receives encryption instruction commands and plaintext data from the host 101. The security IP 102 encrypts the plaintext data attached to the encryption instruction command and outputs the encrypted data to the host 101. The security IP 102 may receive a decryption process command from the host 101. The security IP 102 then decrypts the encrypted data that is input from the host 101 and outputs the decrypted data to the host 101.

The fault injection detector 103 detects the fault injection. In the present embodiment, the detection method of the fault injection used in the fault injection detector 103, it is possible to use a known detection technique. For example, the fault injection detector 103 is implemented corresponding to the portion which becomes a target of fault injection attack in the semiconductor device 100. In the present embodiment, the fault injection detector 103 is assumed to be mounted corresponding to the external power supply terminal. Specifically, the fault injection detector 103 is mounted in the vicinity of the external power supply terminal, for example, within a predetermined distance from the external power supply terminal.

In the present embodiment, it assumes a glitch attack to the power supply terminal as a fault injection. The power supply voltage VCC is provided to the semiconductor device 100 from the external power supply terminal. In the semiconductor device 100, the host 101 and the security IP 102 are operated by the power supply voltage VCC. The fault injection detector 103 monitors the supply voltage VCC and detections voltage glitches. In case of detecting a fault injection, the fault injection detector 103 outputs a fault detection signal to the host 101. The host 101 outputs a validation instruction command to the security IP 102 if a fault detection signal is inputted.

The security IP 102 includes a controller 121, an encryption module 125 and a comparator 130. The controller 121 controls operation of the security IP 102 and the comparator 130. The controller 121 includes a command reception unit 122 and a verification unit 123. The command reception unit 122 receives a command from the host 101 and decodes the received command. If the received command is an encryption processing instruction command, the command reception unit 122 instructs the encryption module 125 to encrypt the plaintext data to be added to the encryption processing instruction command.

The command reception unit 122, when the received command is a verification instruction command, instructs the verification unit 123 to verify the encrypted data. The command reception unit 122 instructs the verification unit 123 to perform verification of the encrypted data when the verification instruction command is input when the encrypted data is generated, for example, in the encryption module 125. When verification is instructed, the verification unit 123 activates the verification function of the encrypted data in the security IP 102. In this embodiment, Doubling method is used to verify the encrypted data. When the verification execution is instructed, the verification unit 123 enables Doubling function. The verification unit 123, for example, a predetermined signal for enabling Doubling function, by outputting to the encryption module 125 and the comparator 130, to enable Doubling function. The controller 121 can be configured with a hardware sequencer and/or a CPU.

The encryption module 125 includes a buffer 126 and an encryption processing unit 127. The buffer 126 stores data to be encrypted, i.e., plaintext data. The encryption processing unit 127 encrypts plaintext data stored in the buffer 126. The encryption processing unit 127 encrypts the plaintext data by a predetermined encryption system such as AES (Advanced Encryption Standard), for example. The encryption processing unit 127 transfers data obtained by encrypting the plaintext data, that is, the encrypted data to the comparator 130.

The comparator 130 has a register 131. The register 131 stores the encrypted data transferred from the encryption processing unit 127. The encrypted data stored in the register 131 is also referred to as the first encrypted data. If Doubling function is not enabled, the controller 121 transmits encrypted data to the host 101 encrypted by the encryption module 125. The controller 121, for example, reads encrypted data from the register 131 and transmits the read encrypted data to the host 101.

When Doubling function is enabled, the verification unit 123 instructs the encryption module 125 to re-encrypt the plaintext data. When Doubling function is enabled, the encryption processing unit 127 encrypts the plaintext data stored in the buffer 126 again and transmits the re-encrypted data to the comparator 130. The re-encrypted data is also called the second encrypted data. The comparator 130 compares the encrypted data stored in the register 131 with the re-encrypted data if Doubling function is enabled. The register 131 may store the initial encrypted data and the re-encrypted data if Doubling function is enabled.

The controller 121 verifies the encrypted data stored in the register 131 according to the comparison result in the comparator 130 and determines whether the encrypted data is valid. The controller 121 determines whether to transmit the encrypted data to the host 101 or to suppress transmission of the encrypted data to the host 101, depending on the verification results of the encrypted data. If a comparison result is available at the comparator 130 that the two encrypted data matches, then controller 121 determines that the encrypted data is valid and transmits the encrypted data to the host 101. If there is a comparison result in the comparator 130 that the two encrypted data do not match, the controller 121 determines that the encrypted data is not valid. In this case, the controller 121 notifies the host 101 of the error without transmitting the encrypted data to the host 101.

### Operation Procedure

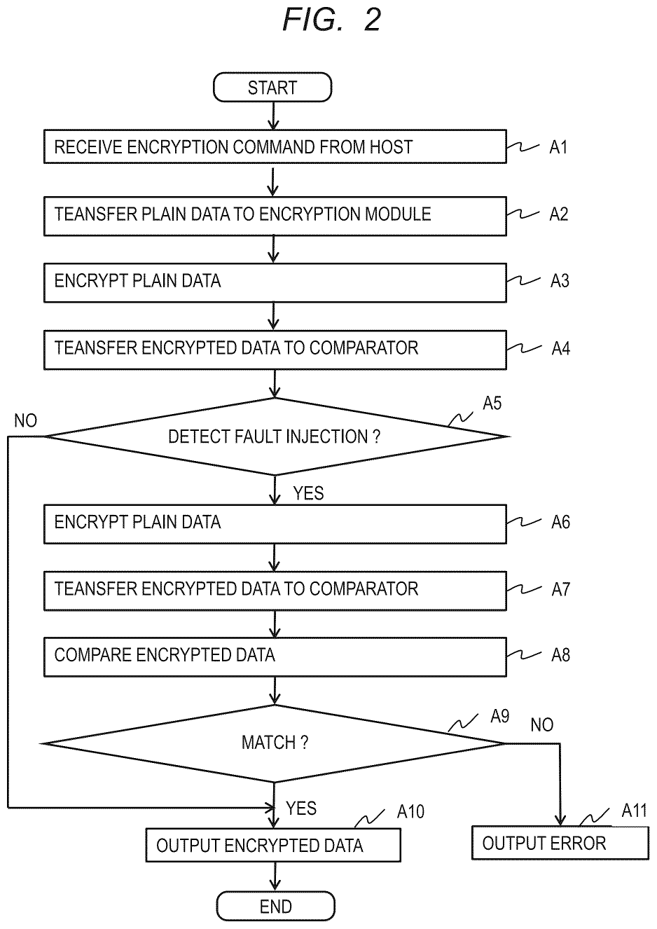

FIG. 2 shows the operation procedure in the semiconductor device 100. At least a portion of the operational procedure shown in FIG. 2 corresponds to the fault injection determination method. The host 101 transmits encryption instruction commands and plaintext data to the secure IP 102. In the security IP 102, the controller 121 receives encryption instruction commands transmitted from the host 101 (in step A1). In step A1, the command reception unit 122 of the controller 121 decodes the command received from the host 101 and recognizes that the received command is an encryption instruction command.

The controller 121 transmits the plaintext data attached to the encryption processing instruction command to the encryption module 125 (in step A2). The encryption module 125 stores transmitted plaintext data in a buffer 126. The encryption processing unit 127 encrypts the plaintext data stored in the buffer 126 (in step A3). The encryption processing unit 127 transfers the encrypted data, which is encrypted in step A3, to the comparator 130 (in step A4). The comparator 130 stores the transferred encrypted data in register 131.

The controller 121 determines whether the fault injection is detected (in step A5). If a fault injection is detected during the step A1 to step A4, the fault injection detector 103 outputs a fault detection signal to the host 101. The host 101 sends a validation instruction command to the security IP 102 if a fault detection signal is entered. When the controller 121 receives the verification instruction command from the host 101, it determines in the step A5 that a fault injection has been detected. The controller 121 determines that no fault injection has been detected if no verification instruction command has been received from the host 101.

If step A5 determines that no fault injection has been detected, the controller 121 reads the encrypted data stored in the register 131 of the comparator 130. The controller 121 transmits the read encrypted data to the host 101 (in step A10). The host 101 obtains the encrypted data from the security IP 102.

If it is determined in the step A5 that a fault injection has been detected, the verification unit 123 of the controller 121 instructs the encryption module 125 to re-encrypt the plaintext data. In the encryption module 125, the encryption processing unit 127 re-encrypts the plaintext data stored in the buffer 126 (in step A6). The encryption processing unit 127 transfers the encrypted data, which is encrypted in step A6, to the comparator 130 (in step A7).

The comparator 130 compares the encrypted data stored in the register 131 with the encrypted data transferred at the step A7 (in step A8). The verification unit 123 reads out the comparison result of the comparator 130 and determines whether or not the encrypted data matches (in step A9). If the verification unit 123 determines that the encryption data does not match, it determines that the encryption data is not valid, and determines that a fault injection attack has been performed. The controller 121 then notifies the host 101 of the error (in step A11). When it is determined that the encrypted data matches in step A9 of steps, the verification unit 123 determines that the fault injection has been erroneously detected due to noise or the like. The process proceeds to step A10 in which the controller 121 transmits encrypted data to the host 101.

In the present embodiment, the fault injection detector 103 detects the fault injection. In this embodiment, the encryption module 125 verifies the validity of the encrypted data in a Doubling method when fault injection is detected. In this embodiment, even if fault injection is erroneously detected due to noise, if the encrypted data is determined to be valid, the security IP 102 transmits the encrypted data to the host 101.

In this embodiment, the encryption module 125 may perform two encryption operations if fault injection is detected in the fault injection detector 103, and there is no need to always perform two encryption operations. Therefore, the encryption module 125 does not need to have two encryption processing units 127. In the present exemplary embodiment, only one encryption processing unit 127 is mounted in the encryption module 125, and the present exemplary embodiment can suppress an increase in the mounting cost of the encryption processing unit.

Further, the present embodiment can reduce power consumption as compared with the case where two encryption processing units 127 are mounted. In the present exemplary embodiment, the security IP 102 combines the detection result of the fault injection detector 103 with the verification result of the encrypted data to distinguish between false detection caused by noise and detection caused by a fault injection attack. Therefore, the present embodiment can suppress the false detection of the fault injection without an increase in the mounting cost of the encryption processing unit.

### Second Embodiment

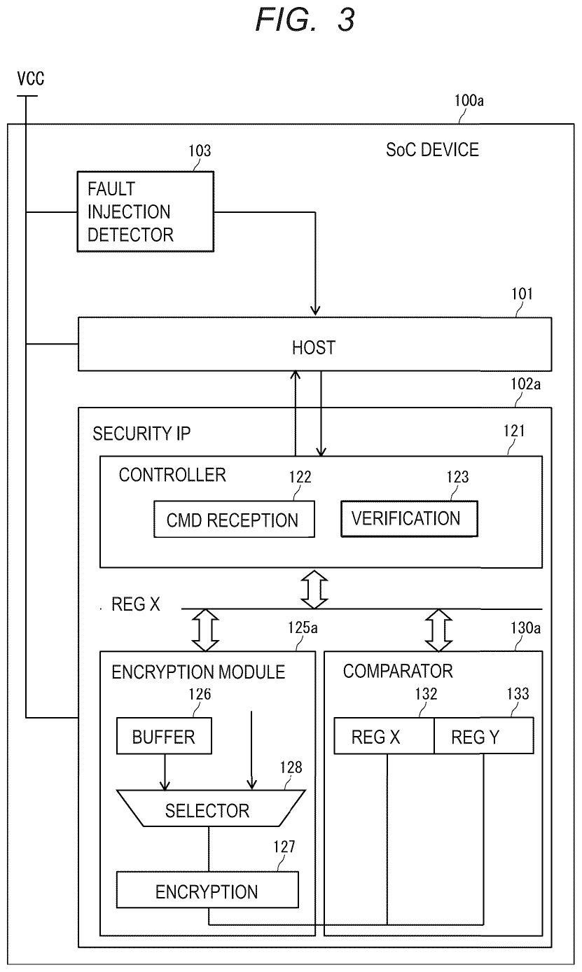

FIG. 3 shows a configuration example of a semiconductor device according to a second embodiment of the present disclosure. This embodiment differs from the configuration of the security IP 102 included in the semiconductor device 100 according to the first embodiment shown in FIG. 1 in the configuration of the security IP 102a included in the semiconductor device 100a. In the present embodiment, the point that Verification method is used to verify the encrypted data differs from the first embodiment.

In the present embodiment, the command reception unit 122 of the controller 121, when the received command is a verification instruction command, instructs the verification unit 123 to verify the encrypted data. When the verification execution is instructed, the verification unit 123 enables Verification function. The verification unit 123, for example, a predetermined signal for enabling Verification function, by outputting to the encryption module 125a, and the comparator 130a, to enable Verification function.

In the present exemplary embodiment, the encryption module 125a includes a buffer 126, an encryption processing unit 127 and a selector 128. The comparator 130a also has a register X 132 and a register Y 133. The selector 128 selects a path of plaintext data stored in the buffer 126 or a path of data input from the controller 121 in response to a select signal output from the controller 121. If Verification function is not enabled, the selector 128 selects the path of plaintext data stored in the buffer 126. In this case, the encryption processing unit 127 encrypts the plaintext data input through the selector 128 and generates the encrypted data. The encryption processing unit 127 transfers the encrypted data to the comparator 130a. In the comparator 130a, the register X 132 stores the transmitted encrypted data.

If verification function is enabled, the controller 121 changes the select signal going to the selector 128 and causes the selector 128 to select the path of the data coming from the controller 121. The controller 121 also reads the encrypted data from the register X 132 and enters it into the selector 128 of the encryption module 125a. The selector 128 selects the path of the data input from the controller 121 and outputs the encrypted data to the encryption processing unit 127. The encryption processing unit 127 performs a decryption process on the input encrypted data and generates decryption data. The encryption processing unit 127 transfers the decoded data to the comparator 130a. In the comparator 130a, the register Y 133 stores the transmitted decoded data.

If verification function is enabled, the controller 121 retrieve plaintext data from the buffer 126 of the encryption module 125a. The controller 121 forward the acquired plaintext data to the comparator 130a. The comparator 130a compares the transmitted plaintext data with the decoded data stored in the register Y 133.

The controller 121 verifies the encrypted data stored in the register X 132 according to the comparison result in the comparator 130a and determines whether the encrypted data is valid or not. If the comparator 130a provides a comparison that the plaintext data matches the decoded data, then the controller 121 determines that the encrypted data is valid. In this case, the controller 121 transmits the encrypted data to the host 101. If the comparator 130a provides a comparison that the plaintext data and the decoded data do not coincide, the controller 121 determines that the encrypted data is not valid. In this case, the controller 121 notifies the host 101 of the error without transmitting the encrypted data to the host 101.

### Operation Procedure

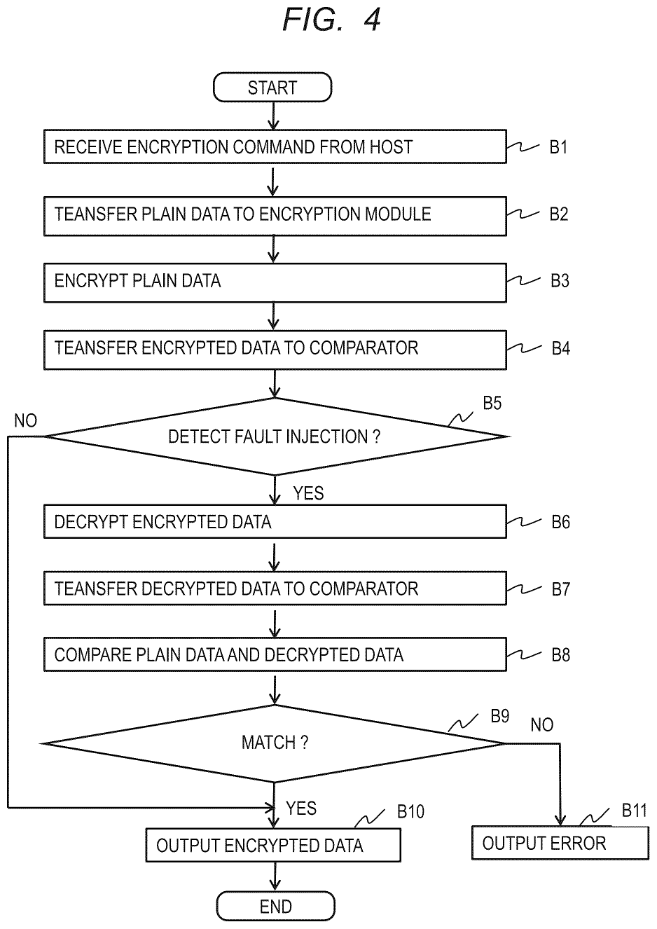

FIG. 4 shows the operation procedure in the semiconductor device 100a. The host 101 transmits encryption instruction commands and plaintext data to the secure IP 102a. In the security IP 102a, the controller 121 receives encryption instruction commands transmitted from the host 101 (in step B1). The controller 121 transmits the plaintext data attached to the encryption processing instruction command to the encryption module 125a (in step B2).

The encryption module 125a stores the transmitted plaintext data in the buffer 126. In the encryption module 125a, if Verification function is not enabled, the selector 128 selects the path of the buffer 126. The encryption processing unit 127 encrypts the plaintext data inputted via the selector 128 and stored in the buffer 126 (in step B3). The encryption processing unit 127 transfers the encrypted data, which is encrypted in step B3, to the comparator 130a (in step B4). The comparator 130a stores the transmitted encrypted data in a register X 132.

The controller 121 determines whether the fault injection is detected (in step B5). If the step B5 determines that no fault injection has been detected, controller 121 reads the encrypted data stored in the register X 132 of the comparator 130a. The controller 121 transmits the read encrypted data to the host 101 (in step B10). The host 101 obtains the encrypted data from the security IP 102a. The steps B1 to B5 and step B10 may be similar to the steps A1 to A5 and A10 shown in FIG. 2.

If it is determined that the fault injection is detected in step B5, the verification unit 123 of the controller 121 performs verification function. The controller 121 also changes the select signal to be output to the selector 128. When the select signal is changed, the selector 128 selects the path of the data input from the controller 121. The controller 121 reads the encrypted data stored in the register X 132 and inputs the read encrypted data into the selector 128. The controller 121 also instructs the encryption module 125a to decrypt the encrypted data. The encryption processing unit 127 decrypts the encrypted data inputted via the selector 128 (in step B6). The encryption processing unit 127 transfers the decoded data decoded in step B6 to the comparator 130a (in step B7). In the comparator 130a, the register Y 133 stores the transmitted decoded data.

The controller 121 reads the plaintext data from the buffer 126 of the encryption module 125a and transfers the read plaintext data to the comparator 130a. The comparator 130a compares the plaintext data transferred by the controller 121 with the decrypted data transferred in step B7 (in step B8). The verification unit 123 reads the comparison result of the comparator 130a and determines whether or not the plaintext data and the decoded data coincide (in step B9). When it is determined that the plaintext data and the decrypted data do not match, the verification unit 123 determines that the encrypted data is not valid and determines that a fault injection attack has been performed. The controller 121 then notifies the host 101 of the error (in step B11). When it is determined that the plaintext data and the decoded data coincide in step B9, the verification unit 123 determines that the fault injection has been erroneously detected due to noise or the like. The process proceeds to a step B10 in which the controller 121 transmits the encrypted data to the host 101.

In this embodiment, the encryption module 125a verifies the validity of the encrypted data in a Verification method when fault injection is detected. The encryption module 125a may decrypt the encrypted data when fault injection is detected in fault injection detector 103, and there is no need to decrypt the encrypted data at all times. Therefore, the present embodiment can suppress the decrease of the calculator performance in the encryption module 125a when fault injection is not detected. In the present exemplary embodiment, the security IP 102 combines the detection result of the fault injection detector 103 with the verification result of the encrypted data to distinguish between false detection caused by noise and detection caused by a fault injection attack. Therefore, the present embodiment can suppress the false detection of the fault injection while suppressing the deterioration of the operation performance in the encryption processing unit.

### Modification

In the first embodiment and the second embodiment, the controller 121 of the security IP 102 is notified that fault injection has been detected through the host 101. However, the present disclosure is not limited thereto. The detection fault injection may be notified from the fault injection detector 103 to the controller 121 directly, for example, without passing through the host 101.

Also, in the present disclosure, the fault injection detector 103 may be implemented corresponding to a module that is targeted for a fault injection attack, such as a security IP 102. For example, the fault injection detector 103 may be implemented inside the module that is the target of the fault injection attack. Alternatively, the fault injection detector 103 may be implemented in the vicinity of the module that is the target of the fault injection attack, for example within a predetermined distance from that module.

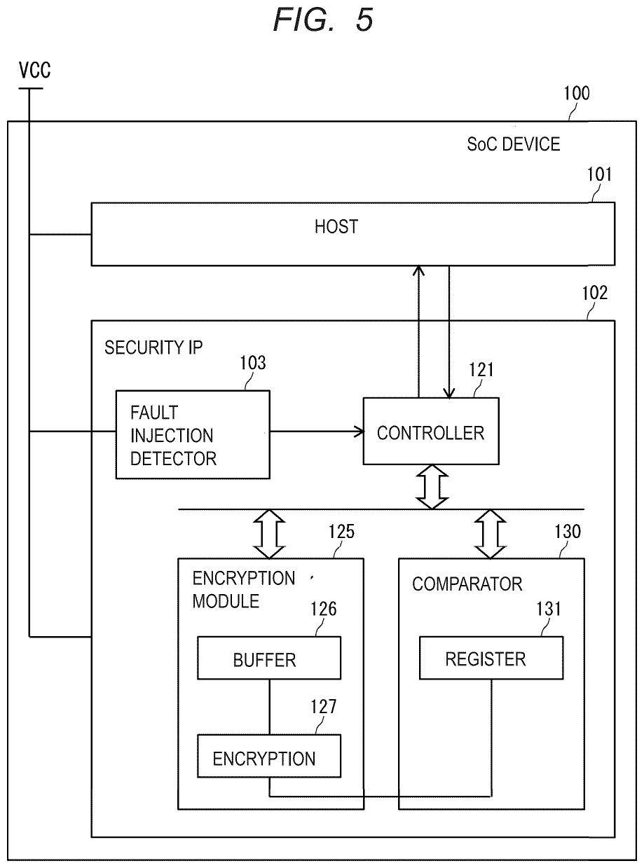

FIG. 5 shows a configuration example of a semiconductor device according to a modification. In this variation, a fault injection detector 103 is implemented within the security IP 102. The fault injection detector 103 outputs a fault detection signal to the controller 121 in the security IP 102. The controller 121, if the fault detection signal is output, performs the operations described in the first embodiment. The configuration in which the fault injection detector 103 is implemented in a security IP 102 is useful for attacks that are directly implemented against a security IP 102, for example, attacks that irradiate electromagnetic waves against a security IP 102.

The fault injection detector 103 may be implemented within, or in the vicinity of, the security IP 102a in the semiconductor device 100a in the embodiment 2 shown in FIG. 3. In that instance, the fault injection detector 103 may output a fault detection signal to the controller 121 in the security IP 102a. The controller 121, if the fault detection signal is output, performs the operations described in the second embodiment.

Although the invention made by the inventor has been specifically described based on the embodiment, the present invention is not limited to the embodiment already described, and it is needless to say that various modifications can be made without departing from the gist thereof.

What is claimed is:

1. A semiconductor device comprising:
a fault injection detector for detecting fault injection,
an encryption module for generating first encrypted data by encrypting plaintext data, and
a controller for determining whether the first encrypted data is valid to verify the first encrypted data generated by the encryption module when the fault injection is detected in the fault injection detector.

2. The semiconductor device according to claim 1,
wherein the controller verifies the first encrypted data when the fault injection is detected when the first encrypted data is generated in the encryption module.

3. The semiconductor device according to claim 1,
wherein the encryption module generates second encrypted data by encrypting the plaintext data when the fault injection is detected, and the controller verifies the first encrypted data based on a comparison result between the first encrypted data and the second encrypted data.

4. The semiconductor device according to claim 3,
wherein when the first encrypted data and the second encrypted data match, the controller determines that the first cryptographic data is valid.

5. The semiconductor device according to claim 3,
wherein the encryption module comprising:
a comparator for comparing the first encrypted data with the second encrypted data,
a buffer for storing the plaintext data, and
an encryption processing unit for generating the first encrypted data and the second encrypted data by encrypting the plaintext data stored in the buffer.

6. The semiconductor device according to claim 1,
wherein the controller verifies the first encrypted data based on a comparison result between the plaintext data and the decrypted data when the fault injection is detected, and the encryption module generates the decrypted data by performing a decryption process on the first encrypted data.

7. The semiconductor device according to claim 6,
wherein the controller determines that the first encrypted data is valid when the plaintext data and the decrypted data match.

8. The semiconductor device according to claim 6,
wherein the encryption module comprising:
a comparator for comparing the plaintext data with the decrypted data,
a buffer for storing the plaintext data,
an encryption processing unit for generating the first encrypted data by encrypting the plaintext data stored in the buffer and generating the decrypted data by decrypting the first encrypted data, and
a selector for selectively inputting the plaintext data and the first encrypted data to the encryption processing unit.

9. The semiconductor device according to claim 1 further comprising a host for transmitting encryption processing instruction commands and the plaintext data to the controller,
wherein the controller transmits the first cryptographic data to the host when the first encrypted data is determined to be valid.

10. The semiconductor device according to claim 9,
wherein the controller does not transmit the first encrypted data to the host when the first encrypted data is determined not to be valid.

11. The semiconductor device according to claim 1,
wherein the fault injection detector is implemented in response to an external interface of the semiconductor device.

12. The semiconductor device according to claim 1,
wherein the fault injection detector is implemented in response to a module that is the target of a fault injection attack.

13. A fault injection determination method including:
an encrypted data is generated by encrypting a plaintext data,
a fault injection is detected, and
the encrypted data is verified and whether or not the encrypted data is valid is determined in response to the detection of the fault injection.
